(19) United States
(12) Patent Application Publication
(10) Pub. No.: US 2019/0384387 A1
(43) Pub. Date: Dec. 19, 2019

(54) Area-of-Interest (AOI) Control for Time-of-Flight (TOF) Sensors Used in Video Eyetrackers

(71) Applicant: LC Technologies, Inc., Fairfax, VA (US)

(72) Inventors: Dixon Cleveland, Annandale, VA (US); Peter L. Norloff, Oakton, VA (US); Matthew Norloff, Oakton, VA (US)

(21) Appl. No.: 16/434,528

(22) Filed: Jun. 7, 2019

Related U.S. Application Data
(60) Provisional application No. 62/685,679, filed on Jun. 15, 2018.

(51) Int. Cl. G06F 3/01; G06T 7/70; G06K 9/32; G06K 9/00

(52) U.S. Cl. CPC G06F 3/013; G06T 7/70; G06T 2207/30201; G06K 9/00604; G06T 2207/30041; G06K 9/3233

(57) ABSTRACT

In video eyetracking, precise measurement of the camera-to-eye distance is critical to the accurate calculation of the user's gazepoint and/or gaze line in space. In various embodiments, a narrow-beam time-of-flight (TOF) range finder device is used to measure the camera-to-eye distance in a video eyetracker. The narrow beam of light, electronically directed toward the eye, provides a consistent measurement to the eye itself, despite varying head positions and orientations as the user moves around freely within the eyetracker camera's field of view. The direction controls that keep the narrow light beam pointed at the eye are obtained from the eyetracker's eye-detection functions that process the eye images captured by the eyetracker's video camera.

### CROSS-REFERENCE TO RELATED APPLICATION

This application claims the benefit of U.S. Provisional Patent Application No. 62/685,679, filed Jun. 15, 2018, the content of which is incorporated by reference herein in its entirety.

### INTRODUCTION

The teachings herein relate to eyetracking. More specifically, systems and methods are provided that use a time-of-flight (TOF) sensor to measure the distance between an eyetracking camera and one or both eyes of a user. The distance to one or both eyes of a user is measured by controlling an area-of-interest (AOI) of the TOF sensor as the head moves around within the TOF's maximum field of view.

### Eyetracking Background

In video eyetracking precise measurement of the camera-to-eye distance is critical to the accurate calculation of the user's gazepoint and/or gaze line in space. Specifically, in video eyetrackers that use the pupil-center corneal reflection (PCCR) method, the accurate estimation of the user gazeline and/or gazepoint in space depends directly on knowledge of the eye's spatial location and angular orientation within the eyetracker camera's coordinate frame. While the horizontal (yaw, x) and vertical (pitch, y) angles of the eye location within the camera frame of reference may be accurately computed from analysis of the position of the eye image within the camera image, the longitudinal (range, z) coordinate, i.e., the camera-to-eye distance D_{eye} from the center of camera's objective lens plane to the center of the eye's corneal sphere, must also be accurately measured.

The following example illustrates the sensitivity of gazepoint accuracy to D_{eye}. A geometric raytrace analysis for a person sitting about 60 cm from a computer screen (that has a remote eyetracking camera mounted below the screen), shows that a camera-to-eye distance error of 1.0 centimeter results in an average gazepoint tracking error on the screen of about 0.7 cm. This magnitude of error is significant for eyetracking applications that require unambiguous differentiation of gazepoints between objects that are 1.4 cm apart or less. For a person with physical disabilities who is typing with his eyes, a 1.4 cm key separation is typical, so it is necessary that the eyetracker has camera-to-eye distance data with at least 1 cm accuracy.

In the physical modeling equations used to predict gaze data such as gazepoints and gazelines, the camera-to-eye distance D_{eye} is optimally defined as the distance from the center of the camera lens plane (the first nodal point of the camera lens through which all the camera's unrefracted rays travel through the camera lens pupil) to the center of corneal sphere (the first nodal point of the eye through which all the eye's unrefracted rays travel through the eye's lens pupil).

Several methods are used in the current video eyetracking art to measure the camera-to-eye distance. Three exemplary methods are described below.

In the Dual Illuminator/Dual Corneal Reflection Method for measuring camera-to-eye distance, two (or more) spatially separated illuminators are used to illuminate the eye. Each of these multiple illuminators generates its own reflection off of the eye's cornea and forms a corneal reflection image within the camera image. Given a spherical reflection surface, the geometric pattern of the corneal reflections within the camera image matches the geometric pattern of the illuminator mounting locations. As the camera-to-eye distance changes, the size of the illuminator pattern in the camera image changes correspondingly, so the camera-to-eye distance can be estimated from the measured distances between the illuminator reflection images within the overall camera image.

One limitation in the dual/corneal reflection method arises because the corneal surface of the eye is not completely spherical. Typically, the corneal surface flattens out toward the edges of the iris. Thus, for example, when a person rotates the direction of his gaze away from the camera, the illuminator reflection pattern moves from the center of the cornea toward the edge of the cornea. In this case, the differing shape of the corneal surface in the region of the illuminator reflections causes the size of the reflected pattern to change, in turn producing a changed eye distance measurement even when the actual camera-to-eye distance has not changed.

In the Stereoscopic Face/Eye Detection Method for measuring camera-to-eye distance, two (or more) laterally separated face-detection cameras (e.g., separated within a plane roughly perpendicular to the eyetracking camera's pointing axis, z) are pointed at the face, and face detection software is used to find the locations of the user's eye images within the respective face-camera images. Stereoscopic analysis of each eye image location within the different face camera images produces a camera-to-eye distance measurement to each eye.

A disadvantage of the Stereoscopic Face/Eye Detection method is that it requires additional face-detection camera hardware beyond the eyetracker's eyetracking camera(s).

In the Asymmetric Aperture Method for measuring camera-to-eye distance (Focus Control System, U.S. Pat. No. 4,974,010), the lens of the eyetracking camera is fitted with an aperture whose shape is asymmetric (as opposed to the traditional circular aperture), and the resulting shape of the corneal reflection image is analyzed to determine how far the eye is before or beyond the camera's focus plane. The total camera-to-eye distance is then computed as the sum of the camera's focus distance and the offset of the eye from the focus plane.

A disadvantage of the Asymmetric Aperture Method is that it requires a large entrance pupil on the eyetracking camera lens. A large lens limits miniaturization of the eyetracker equipment.

Additional systems and methods are needed to precisely measure the camera-to-eye distance in video eye tracking that are less expensive than current methods and allow the eyetracker equipment to be miniaturized.

### SUMMARY

A system, method, and computer program product are disclosed for eyetracking, in accordance with various embodiments. The system includes an eyetracking camera, a processor, and a light imaging and ranging time-of-flight (TOF) device.

The eyetracking camera captures at least one eye image (typically but not necessarily a 2-dimensional image) of at least one eye of a user. The TOF device measures a TOF-to-eye range (generally along a z axis roughly perpendicular to the camera image plane) from the TOF device to the at least one eye.

The processor receives the measured TOF-to-eye range from the TOF device and the at least one eye image from the eyetracking camera. The processor next identifies the image of the at least one eye within the at least one eyetracking camera image. Finally, the processor calculates one or more of an eye spatial location of the at least one eye in a three-dimensional (3D) space, an eye angular orientation of the at least one eye in the 3D space, a gazeline of the at least one eye in the 3D space, and a location of a gazepoint of the at least one eye in the 3D space. To perform these one or more calculations (which are based on the physical geometry of the eye, the location of eyetracking camera, the location of the TOF device, and the location and orientation of the eye and the eyetracking camera within the 3D viewing space), the processor uses the measured TOF-to-eye range from the TOF device to the at least one eye and the at least one eyetracking camera image.

These and other features of the applicant's teachings are set forth herein.

### BRIEF DESCRIPTION OF THE APPENDICES AND DRAWINGS

Appendix 1 is an exemplary description of the use of TOF range detectors in video eyetracking, in accordance with various embodiments.

FIG. 1 is a block diagram that illustrates a computer system, in accordance with various embodiments.

FIG. 2 is a schematic diagram showing an eyetracker, in accordance with various embodiments.

FIG. 3 is a schematic diagram showing an eyetracker that includes an eyefollower, in accordance with various embodiments.

FIG. 4 is a schematic diagram of a video eye tracking system with TOF range detection using a single, broad AOI beam directed to a region including both eyes, in accordance with various embodiments.

FIG. 5 is a schematic diagram of a video eye tracking system with TOF range detection that measures the camera-to-eye distance to the two eyes separately by alternating the TOF beam pointing between the two eyes over successive TOF range samples, in accordance with various embodiments.

FIG. 6 is a flowchart showing a method for eyetracking, in accordance with various embodiments.

FIG. 7 is a schematic diagram of a system that includes one or more distinct software modules that perform a method for eyetracking, in accordance with various embodiments.

Before one or more embodiments of the invention are described in detail, one skilled in the art will appreciate that the invention is not limited in its application to the details of construction, the arrangements of components, and the arrangement of steps set forth in the following detailed description or illustrated in the appendices. The invention is capable of other embodiments and of being practiced or being carried out in various ways. Also, it is to be understood that the phraseology and terminology used herein is for the purpose of description and should not be regarded as limiting.

### DETAILED DESCRIPTION

### Computer-Implemented System

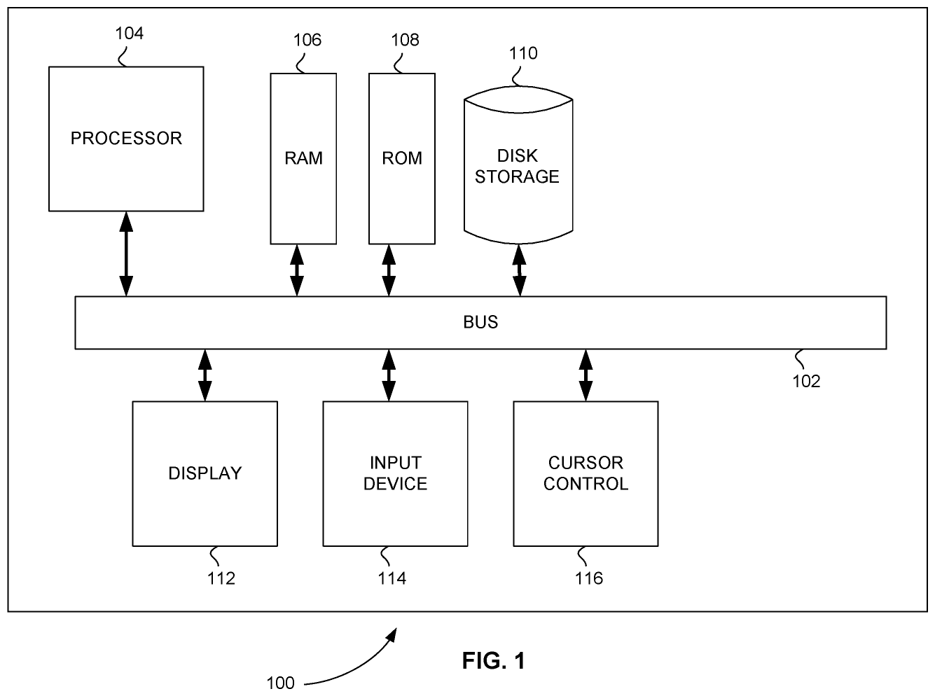

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively, hard-wired circuitry may be used in place of or in combination with software instructions to implement the present teachings. Thus, implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software, but the present teachings may be implemented as a combination of hardware and software or in hardware alone. The present teachings may be implemented with both object-oriented and non-object-oriented programming systems.

### Eyetracker and Eyefollower

In the eyetracking art, an eye's “gazepoint” is typically defined as the point in space where the eye's “gazeline” intercepts the surface of an object within the eye's field of view. Though the eye can “see” over a large solid angle, there is a small region on the retina, called the “macular region,” where the cone density rises significantly higher than the rest of eye's “peripheral vision.” The macular region is roughly 18° across. The cone density at the center of the macular region is especially high. This particularly high-cone-density area is called the “foveola.” The foveola is about 1.2° across and provides the eye's highest image resolution.

When the brain wishes to look at a particular object in space, it commands the ocular muscles to orient the eyeball such that image of that object lands right in the middle the foveola, thus providing maximum image resolution of the specific item we wish to look at.

Because of the existence of the foveola on the eye's retina, it is scientifically convenient to define an imaginary “gazeline” that indicates the primary direction that the eye is pointed. Technically, the gazeline is defined as the straight line that originates at the center of the foveola, passes through the eye's optical nodal point, and extends into the space outside the eye until it reaches the particular object that the eye is currently viewing.

To predict a gazepoint, a video eyetracking device generally a) captures successive images of the eye, b) processes the eye images to determine the spatial position of the eye and the angular orientation of the gazeline (with respect to the camera), and c) computes the intersection of the gazeline with the surface (or surfaces) that the user is viewing. To track the gazepoint accurately and reliably as the user moves his gaze and/or his head, the eyetracker must accommodate all the physically relevant parameters of the gazeline, including the eyeball position within the camera's spatial coordinate frame, the gazeline orientation from the eyeball location, and the spatial location of the viewed objects within the camera coordinate frame. Since the gazeline physics determines the user's real gazepoint, the eyetracker's gaze-line model must accurately account for all the physically relevant gazeline variables. Note that the gazeline model need not necessarily compute all the gazeline variables explicitly, but it must somehow account for them in a physically meaningful way. Gazeline models that do not explicitly compute all the gazeline variables are often called implicit, or lumped-parameter models.

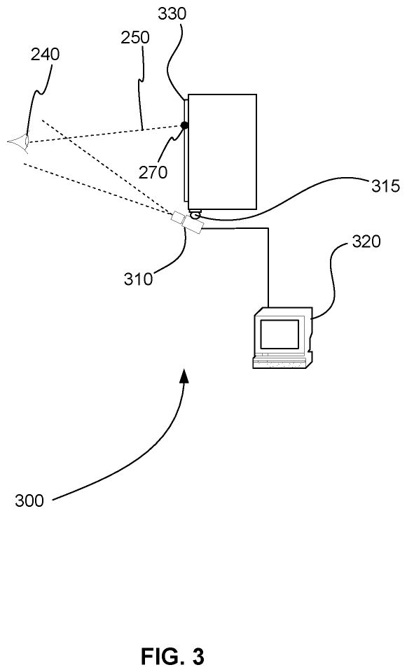

An example of a gazeline for a user looking at a flat surface such as a computer screen is illustrated in FIG. 3. Note that the camera image of the eye contains measurable information about the eye's spatial position and angular orientation, but that eye position/orientation information is measured with respect to the camera frame of reference, not with respect to the computer screen that the user is actually viewing. Thus, the gazeline model needs a way to convert the eye position and direction data from the camera frame of reference to the monitor frame. Once the eye position and direction data are known within the monitor coordinate frame, it is possible to compute the gaze coordinate on the monitor screen, using the mathematics of computing the intersection of a line with a plane.

In general, an eyetracker or an eyegaze system is a device that is used to determine where an eye is looking. Modern eyetrackers, sometimes referred to as video eyetrackers, are camera-based devices that observe a person's eyes and predict the point in space where the person is looking. This point in space is referred to as the gazepoint, for example. The line connecting the fovea of the eye, the center of the eye pupil, and the gazepoint is referred to as the gaze line, for example (also see Paragraph 38).

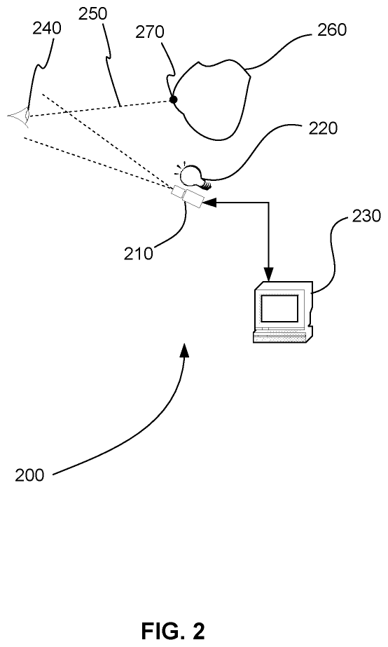

FIG. 2 is a schematic diagram showing an eyetracker 200, in accordance with various embodiments. Eyetracker 200 includes camera 210, illumination source 220, and processor 230. Illumination source 220 illuminates eye 240, and camera 210 images eye 240. Processor 230 receives the image from eyetracking camera 210 and determines the position and focus condition of eye 240 within the camera image. Based on the position and focus condition of the eye within the camera image, the processor is able to compute the 3D spatial location and angular orientation of actual eye 240 within the camera body frame of reference. In turn, based on the spatial location and angular orientation of eye 240, the processor computes gazeline 250. The point in space where gazeline 250 intercepts a viewed object 260 is defined to be eye 240's gazepoint 270.

Eyetracker 200 can include additional elements. For example, eyetracker 200 can include one or more additional cameras (not shown) or one or more additional optical devices (not shown) to determine the camera-to-eye distance from eyetracking camera 210 to eye 240. Eyetracker 200 can also include a display (not shown) to determine the gazepoint in an image displayed by processor 230 on the display.

An important objective of many eyetrackers is to allow the user to move his head freely while the eyetracker continues to track the user's gaze with high accuracy. Typical head motions involve moving (translating) the head from side to side, up and down, and back and forth; and involve rotating the head forward and back (pitching or nodding), rotating the face from left to right (yawing or shaking), and rotating the head toward one shoulder or the other (rolling). One method for minimizing head motion with respect to an eyetracking device is to place the eyetracker device on the user's head, attached to a pair of glasses, for example. In many applications, however, it is desired to position the eye eyetracking device at a remote, off-head location. Accommodating head motion with respect to the eyetracker platform is particularly relevant to the objective of capturing high quality, high resolution eye images in remote eyetrackers.

To accommodate variable positions and orientations of the head with respect to the eyetracker platform, eyetrackers may include mechanized devices to keep the eyetracking camera(s) physically pointed at and/or focused on the user's eye(s). A motorized pan-tilt device, such as a gimbal, may be used, for example, to keep the camera's view direction pointed at the eye or eyes; and a focus motor may be used to keep the eye(s) in focus. Eyetrackers that utilize such mechanical means to automatically point or focus their eyetracking cameras on the eyes are sometimes referred to as eyefollowers.

FIG. 3 is a schematic diagram showing an eyetracker 300 that includes an eyefollower, in accordance with various embodiments. Eyetracker 300 includes camera 310, gimbal 315, and processor 320. The eyefollower portion of eyetracker 300 includes, for example, a mechanical configuration comprising gimbal 315 and a motorized lens (not shown) for camera 310 that implements a variable-focus range. The eyefollower portion of eyetracker 300 may also include a motorized zoom capability (not shown) for camera 310 that implements a variable zoom. Gimbal 315 controls the yaw (pan) and pitch (tilt) of camera 310, which, in turn, are used to follow a user's eye 240 as the user moves his head and/or eye 240 from side to side and up and down, respectively. The motorized lens for camera 310 is used to follow the user's eye 240 as the user moves his head forward or backward, and it may also be used in the computation of the distance from the camera to the eye based on a measurement of the lens length required to put the eye in focus. The motorized zoom for camera 310 may be used to control the desired size, i.e., pixel resolution, of the eye image within the camera image as the user moves his head forward and backward. Gimbal 315 can be optionally secured to display 330, mechanically linking the coordinate system of camera 310 to display 330, for example. Note that camera 310 can also include an illumination source (not shown).

Processor 320, for example, executes control loop algorithms required to keep the camera pointed at, focused on, and zoomed on eye 240 as the user moves his head. Processor 320 also executes, for example, algorithms used to solve rigorous trigonometric gazepoint tracking equations, referred to as “explicit raytrace algorithms.” These explicit raytrace algorithms are used to accurately compute the user's gazeline 230 and predict the user's gazepoint 270 on display 330, fully accommodating the variable camera geometry and the moving head and/or eye 240.

### Use of TOF Range Detectors in Video Eyetracking

As described above, in video eyetracking, precise measurement of the camera-to-eye distance is critical to the accurate calculation of the user's gazepoint and/or gaze line in space. Several methods are used in the current video eyetracking art to measure the camera-to-eye distance. Three exemplary methods are the dual illuminator/dual corneal reflection method, the stereoscopic face/eye detection method, and the asymmetric aperture method. The dual illuminator/dual corneal reflection method can produce incorrect camera-to-eye distance measurements when a person rotates the direction of his gaze away from the camera. The stereoscopic face/eye detection method requires additional camera hardware beyond the eyetracker's eyetracking camera(s). The asymmetric aperture method requires a large entrance pupil on the eyetracking camera lens that limits miniaturization of the eyetracker equipment.

As a result, additional systems and methods are needed to precisely measure the camera-to-eye distance in video eye tracking that allow rotation of gaze away from the eyetracker camera, that do not require additional cameras, that are less expensive than current methods, and that allow the eyetracker equipment to be miniaturaized.

Light detection and ranging (LIDAR) is a sensing method that measures distance by directing a pulsed laser towards a target and measuring the reflected light pulses using a sensor. A time-of-flight (TOF) LIDAR, TOF sensor, TOF camera, or TOF range finder is a device that measures the time of flight of a transmitted/reflected/received light pulse to measure the range to an object. In various embodiments, a TOF range finder is used to precisely measure the camera-to-eye distance in video eye tracking. In comparison to the current range finding methods described above, a TOF range finder is generally smaller and less expensive. In a video eye tracking system, a) a TOF range finder is preferably mounted immediately adjacent to the eyetracker camera lens and pointing close to the same direction as the camera, is used to measure a “raw” TOF-to-eye range R_{TOF} from the TOF sensor surface to a reflection surface on the face, and b) the camera-to-eye distance D_{eye} is computed by adding known “distance offset terms” to the raw R_{TOF} measurement:

D_{eye}=R_{TOF}+distance offset terms.

The distance offset terms account for range offsets at each end of the raw TOF range measurement: at the TOF sensor end of the measurement, the distance offset term represents any longitudinal mounting offset (along the z-axis) of the TOF sensor surface with respect to the camera lens plane. At the eye/face end of the measurement, the distance offset term represents any longitudinal offset (along the z-axis) between the TOF-detected facial surface and the anatomical center of eye's corneal sphere. The values for the distance offset terms are often, but not necessarily, specified during product design and remain constant during eyetracking runtime. In this case, the only time varying variable contributing to the D_{eye} equation is the TOF range measurement from the sensor to the reflection surface on the face.

When using a raw TOF range measurement R_{TOF} as the basis for computing the camera-to-eye distance D_{eye} in a video eyetracker, there are conflicting goals regarding the design/implementation of the TOF field of view. On one hand, the device should have a wide field of view to be able to provide useful range measurements as the user moves his head freely throughout the eyetracking camera's field of view. On the other hand, it is desired to have a narrow field of view that measures the range to the eye alone, not the range to other areas of the face, such as the nose, chin, and hair.

The human face, with its protruding nose, protruding chin, and recessed eye sockets, presents an irregular surface. Given that TOF sensor devices typically measure the range to the nearest surface within their field of view, a wide-field-of-view device would be prone to producing varying R_{TOF} ranges as the person rotates his head in different directions, even if the eye itself were to remain at a constant distance from the camera. A narrow field-of-view TOF beam, pointed more specifically at the eye region of the face, is needed to obtain more consistent measures of the camera-to-eye distance.

An effective mechanism for resolving the TOF sensor's wide versus narrow field-of-view conflict is to employ a dynamically programmable area-of-interest (AOI), where the device is able to produce a narrow “composite receiver detection beam” while dynamically controlling the direction of the detection beam over a wide range of viewing angles. (In the image processing field, the term region-of-interest, or ROI, is often used interchangeably with AOI.) One implementation of a programmable AOI, (such as the one provided on the VL53L1 manufactured by ST Microelectronics), consists of a grid of directionally sensitive light detector elements, where each individual element has a relatively narrow detection beam width but is pointed in a slightly different direction than its neighbor. Physically, the TOF device's AOI function forms a controllable composite receiver beam by electronically selecting a subset of individual detector elements, where the spatial profile of the composite receiver beam consists of the superposition of the receiver beam patterns of the selected individual elements. The TOF sensor device generates a “composite received signal” by adding only the received signals from the programmatically selected subset of detector elements within the overall sensor grid. Thus, when the TOF range sensor processes the composite received signal, it effectively measures the “average” range to the specific reflecting surfaces that exist within the selected region (AOI).

The minimum size/area of an AOI in this implementation, of course, is the beam width of a single sensor element, and the overall size/area of the AOI is determined by the overlapping areas of the selected individual detectors. In summary, the full TOF sensor grid provides access to a wide field of view, while the programmable selection of a subset of the grid elements permits the specification of a directed, narrow field of view at any time.

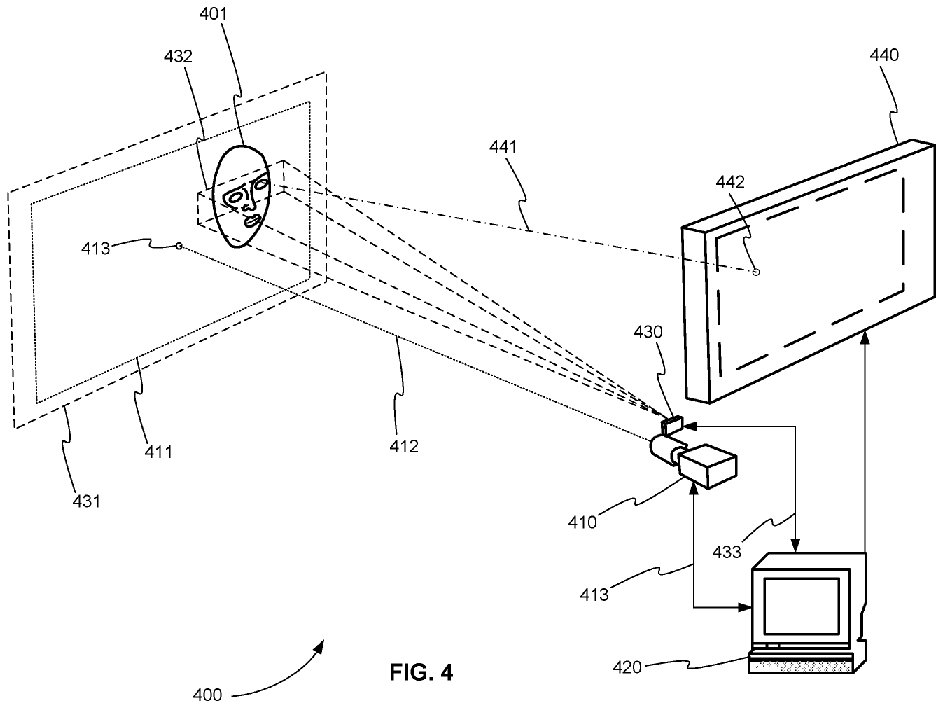

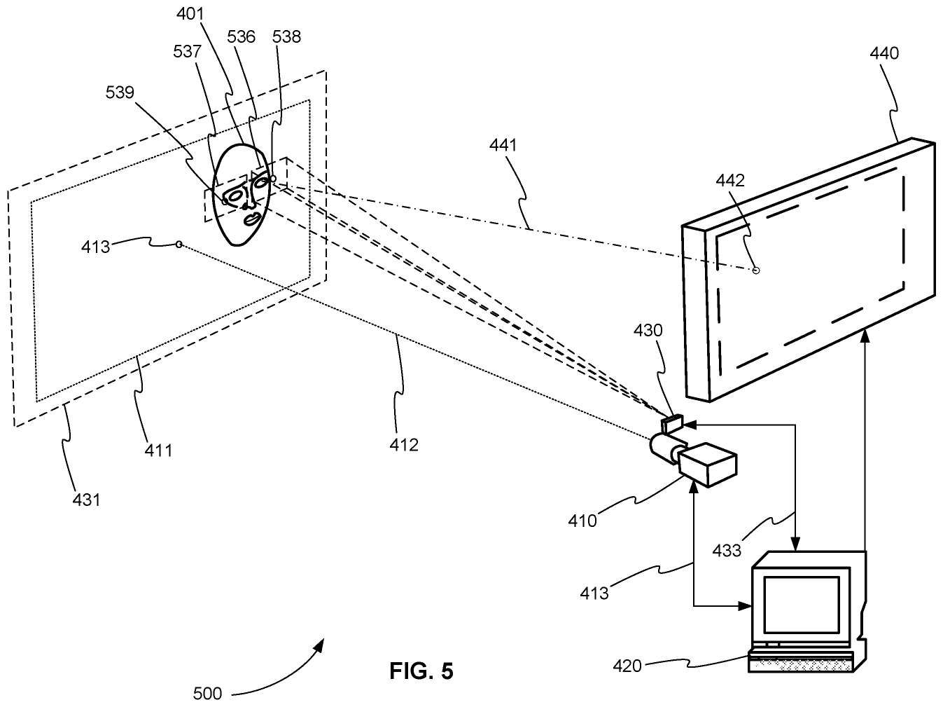

Given the feasibility of pointing a narrow light beam, the next requirement for a video eyetracker design is to develop a control mechanism to keep the beam pointed directly at the eye as the user moves his head around freely. Since (as discussed above) eye-image-processing functions in video eyetrackers measure the location of the eye or eyes within the eyetracker camera image, the camera's yaw and pitch sight angles to the eye(s) are known, so the knowledge of these angles may be utilized to direct the TOF's AOI beam toward the eye(s). As the user moves his head around within the eyetracking camera field of view: a) the eyetracking software continually measures the yaw and pitch position of the eye within the camera field of view, and b) this horizontal and vertical eye location information is passed to the TOF sensor device and used to direct the TOF's light beam AOI so that the beam's total return signal primarily contains responses from the eye area, with minimal response from other portions of the face. See FIGS. 4 and 5.

### TOF Sensor Mounting in Video Eyetrackers

As illustrated in FIG. 4, the TOF sensor device is preferably mounted on the eyetracking camera next to the lens such that a) its sensor plane is longitudinally aligned with the camera's lens plane, b) the light beam's “central” pointing axes (i.e., the center of the light receiver beam that would be formed if all the sensor elements were activated) is horizontally and vertically aligned with the eyetracker camera's pointing axis (z) such that the two devices would both point at the same nominal “center of the user head box” in space, and c) the light beam's roll orientation is aligned with the camera's roll orientation. (In eyetracking lexicon, the user “head box” typically refers to the 3D region of space in which the user can move his head and the eyetracking camera is able to see, and thus track, his eye(s).)

In practice, it may be difficult or expensive to achieve these TOF alignments physically or mechanically, and it may be preferable to implement an operational software correction procedure for insuring that the light beam's actual AOI corresponds to the desired AOI computed by the eyetracker's processor. One method to accommodate for this physical misalignment is to implement the following software-based correction/accommodation. First, the physical misalignment is measured in a one-time calibration process that is performed when the camera/TOF equipment is originally assembled. Second, the measured misalignments are programmed into the eyetracker's processing code. Finally, during runtime when the processor locates the eye(s) within the camera field of view, the known angular misalignment is used to mathematically adjust the specification for the desired light beam AOI.

If the TOF sensor plane is not mounted in the eyetracker lens plane (i.e., is not mounted at a longitudinal position corresponding to a camera range of 0), the raw TOF-to-eye range can be corrected by adding the TOF sensor's mounting offset to the sensor's measured range to compute the actual camera-to-eye distance. (See equation in paragraph 50.)

### Accommodating Current TOF Sensor Design Limitations

For video eyetracking purposes, it would be ideal to obtain a TOF range reflection signal directly from the corneal surface of the eye alone, without any signal from surrounding facial tissue such as nose, cheek or forehead or from other objects such as hair, glasses or other head wear. However, given the current TOF range finding state of the art, it is not economically practical to form either a transmitted light beam or a light receiver beam that can be pointed precisely at the eyeball alone. It is, therefore, desired to provide methods for obtaining useful TOF-to-eye range estimates from broader and less precisely controlled light signal beams. These wider beams typically include the flesh on the bony structure(s) around the eye such as the forehead, cheeks, and nose.

Since the detection mechanism in TOF sensor devices often measure the range to the first major surface the beam encounters, a beam that is wider than the eye, even though pointed directly at the eye, in most cases returns the range to the nose or to the forehead, rather than returning the range to the eyeball itself. As the user rotates his head side to side, the nose may move in and out of the light beam and cause the device to report a measured range variation even though the actual range to the eyeball itself may not have changed at all.

To counteract the particular effect of the nose moving in and out of the light beam, one preferred implementation is to point the beam slightly away from the nose toward the head's temple on the other side of the eye from the nose. As the user rotates his head, the facial structure here remains a fairly constant offset distance from the eye itself, and can largely be accommodated simply by adding a constant distance offset (about a centimeter) to the TOF sensor measurement to obtain a moderately consistent TOF-to-eye range. Thus, even though the center of the AOI is not pointed directly at the eye, a sufficiently reliable TOF-to-eye range is obtained.

TOF Sensors with Only Very Coarse Beam Pointing

With respect to TOF range finders that have no AOI beam pointing capability at all, significant range noise reduction can be achieved with devices that have only relatively coarse AOI capability. In this case, a single, broad AOI beam can be directed to a region including both eyes.

FIG. 4 is a schematic diagram 400 of a video eye tracking system with TOF range detection using a single, broad AOI beam directed to a region including both eyes, in accordance with various embodiments. Though, in eyetrackers that track both eyes, a single camera-to-eye distance must be used in the gaze data calculations for both eyes, the fact that the beam tracks a consistent location on the face provides significantly improved camera-to-eye distance data than a completely fixed field of view.

The eyetracking system of FIG. 4 includes eyetracking camera 410, processor 420, and TOF range finder 430. Eyetracking camera 410 images the eye(s) of user 401 using eyetracking camera field of view 411. Eyetrtacking camera axis 412 is at center 413 of camera field of view 411. Eyetracking camera 410 provides image or video data to processor 420 using TOF communications path 413. Communications path 413 can be a wired or wireless data connection.

TOF range finder 430 similarly has full (or maximum) TOF field of view 431. However, TOF range finder 430 provides a dynamically programmable AOI 432 within full TOF field of view 431. This programmable AOI 432 allows TOF range finder 430 to measure the camera-to-eye distance from TOF range finder 430 to a region including both eyes of user 401. Processor 420 sends control signals to TOF range finder 430 along TOF communications path 433, for example, to program AOI 432 so that it is limited to a region including both eyes of user 401. In turn, TOF range finder 430 sends the measured camera-to-eye distance from TOF range finder 430 to the region including both eyes of user 401 to processor 420 using TOF communications path 433, for example. Communications paths 413 or 433 can be wired or wireless data connections.

The eyetracking system of FIG. 4 can further include display 440 for displaying information to user 401. From the one or more eyetracking camera images provided to processor 420 by eyetracking camera 410, processor 420 determines the angular orientation of at least one eye of user 401. From this angular eye orientation provided by camera 410, from the measured camera-to-eye distance from TOF range finder 430 to the region including both eyes of user 401 provided by TOF range finder 430, and from the known relative positions of camera 410, TOF range finder 430, and display 440, processor 420 calculates gazeline 441 from at least one eye of user 401 to display 440 and gazepoint 442 on display 440.

### Camera-to-Eye Distance Measurement in Binocular Eyetracking

In binocular eyetracking it is generally desired to measure the camera-to-eye distances for the left and right eyes individually. As the user rotates his head over a wide range of pan and tilt angles, the two camera-to-eye distances can differ significantly, and maximally accurate measurement of each eye's gaze data depends on independent measurement each eye's camera-to-eye distance.

In the current TOF ranging state of the art, the data output from a single range sample typically represents a single range value. One method to measure the camera-to-eye distance to the two eyes separately is to alternate the light beam pointing between the two eyes over successive pulse range samples.

FIG. 5 is a schematic diagram 500 of a video eye tracking system with TOF range detection that measures the camera-to-eye distance to the two eyes separately by alternating the TOF beam pointing between the two eyes over successive TOF range samples, in accordance with various embodiments. Like the eyetracking system of FIG. 4, the eyetracking system of FIG. 5 includes eyetracking camera 410, processor 420, and TOF range finder 430. However, in FIG. 5, processor 420 sends control signals to TOF range finder 430 along communications path 433 to program AOI 536 so that it is limited to a region that includes just one eye of user 401. To measure both eyes, processor 420 sends control signals to TOF range finder 430 along communications path 433 so that the camera-to-eye distances to AOI 536 and AOI 537 are alternately measured. AOI 536 is used to measure the camera-to-eye distance to the left eye of user 401, and AOI 537 is used to measure the camera-to-eye distance to the right eye of user 401.

### System for Eyetracking

Returning to FIG. 4, a system for eyetracking includes eyetracking camera 410, processor 420, and LIDAR TOF device 430. Camera 410 captures at least one image of at least one eye of user 401. TOF device 430 measures a TOF-to-eye range from TOF device 430 to the at least one eye.

Processor 420 is in communication with camera 410 and TOF device 430. Processor 420 can be, but is not limited to, an application specific integrated circuit (ASIC), a field programmable gate array (FPGA), a controller, a computer, a microprocessor, the computer system of FIG. 1, or any device capable of sending and receiving control signals and data and performing calculations.

Processor 420 receives the measured TOF-to-eye range from TOF device 430. Processor 420 receives the at least one image from camera 410. Processor 420 identifies the at least one eye within the at least one eyetracking camera image. Finally, processor 420 calculates one or more of a spatial location of the at least one eye in a three-dimensional (3D) space, an angular orientation of the at least one eye in the 3D space, a gazeline of the at least one eye in the 3D space, and a location of a gazepoint of the at least one eye in the 3D space. To perform these one or more calculations, processor 420 uses the measured TOF-to-eye range from TOF device 430 to the at least one eye and the at least one eyetracking camera image.

In various embodiments, TOF device 430 has a programmatically adjustable AOI 432 over which it is sensitive to received light.

In various embodiments, processor 420 further uses the location of the at least one eye within the at least one eyetracking camera image to programmatically adjust AOI 432 of TOF device 430 to align the TOF's AOI in real time on a spatial area of the at least one eye or on a spatial area including both eyes of user 401. Note that AOI 432 of FIG. 4 is aligned with a spatial area including both eyes of user 401. In contrast, for example, AOI 536 of FIG. 5 is aligned with a spatial area including just one eye of user 401.

Returning to FIG. 4, in various embodiments, processor 420 further uses the location of the at least one eye within the at least one image to programmatically adjust an AOI (not shown) of TOF device 430 to align the AOI in real time on a spatial area of the face of user 401 above the at least one eye or above both eyes of the user.

In various embodiments, processor 420 further calculates a camera-to-eye distance from camera 410 to the at least one eye. As discussed in paragraph 50, this camera-to-eye distance is calculated as a sum of a) the raw TOF-to-eye range measured by TOF device 430 and b) a set of known or estimated offset corrections. The set of known or estimated offset corrections includes one or more of i) known or estimated offset corrections between the location of TOF device 430 and the location of camera 410 and ii) known or estimated offset corrections between the location of the at least one eye and a location of other facial features or items attached to a head or a face of user 401 that TOF device 430 detects. (See Paragraph 50.)

In various embodiments, as shown in FIG. 5, AOI 536 is adjusted to include just one eye of user 401.

Returning to FIG. 4, in various embodiments, AOI 432 is adjusted to include both eyes of user 401.

In various embodiments, an AOI (not shown) is adjusted to include a spatial area of the face of user 401 above the at least one eye or above both eyes of user 401.

In various embodiments, as shown in FIG. 5, AOI 536 is adjusted to include only one eye at a time and alternate (AOI 536 and AOI 537) between both eyes of user 401 in order to provide a separate distance measurement for each of the two eyes of user 401.

In various embodiments, AOI 536 is adjusted to have a center 538 on the opposite side of the at least one eye from the nose of user 401. Similarly, AOI 537 is adjusted to have a center 539 on the opposite side of the right eye from the nose of user 401.

### Method for Eye Tracking

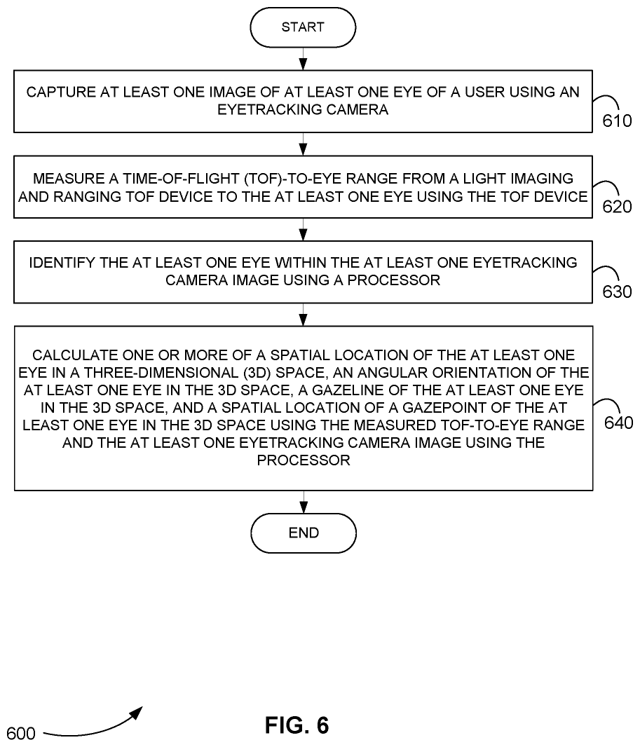

FIG. 6 is a flowchart 600 showing a method for eyetracking, in accordance with various embodiments.

In step 610 of method 600, at least one image of at least one eye of a user is captured using an eyetracking camera.

In step 620, a TOF-to-eye range is measured from a light imaging and ranging TOF device to the at least one eye using the TOF device.

In step 630, the at least one eye is identified within the at least one eyetracking camera image using a processor.

In step 640, one or more of a spatial location of the at least one eye in a 3D space, an angular orientation of the at least one eye in the 3D space, a gazeline of the at least one eye in the 3D space, and a location of a gazepoint of the at least one eye in the 3D space are calculated using the processor. One or more of these values are calculated using the measured TOF-to-eye range and the at least one eyetracking camera image.

### Computer Program Product for Eyetracking

In various embodiments, computer program products include a tangible computer-readable storage medium whose contents include a program with instructions being executed on a processor so as to perform a method for eyetracking. This method is performed by a system that includes one or more distinct software modules.

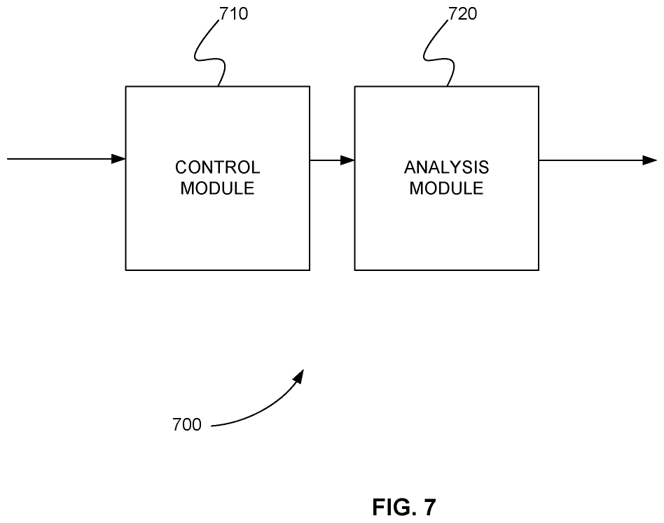

FIG. 7 is a schematic diagram of a system 700 that includes one or more distinct software modules that perform a method for eyetracking, in accordance with various embodiments. System 700 includes a control module 710 and an analysis module 720.

Control module 710 instructs an eyetracking camera to capture at least one image of at least one eye of a user. Control module 710 instructs a TOF device to measure a TOF-to-eye range from the TOF device to the at least one eye.

Analysis module 720 identifies the at least one eye within the at least one image. Analysis module 720 calculates one or more of a spatial location of the at least one eye in a 3D space, an angular orientation of the at least one eye in the 3D space, a gazeline of the at least one eye in the 3D space, and a location of a gazepoint of the at least one eye in the 3D space. One or more of these values are calculated using the measured TOF-to-eye range and the at least one eyetracking camera image.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An eyetracking system, comprising:
an eyetracking camera that captures at least one image of at least one eye of a user;
a light imaging and ranging time-of-flight (TOF) device that measures a TOF-to-eye range from the TOF device to the at least one eye; and
a processor in communication with the eyetracking camera and the TOF device that receives the measured TOF-to-eye range from the TOF device,
receives the at least one eyetracking camera image from the eyetracking camera,
identifies at least one eye image within the at least one eyetracking camera image,
uses the TOF-to-eye range and the at least one eye image to calculate one or more of:
a spatial location of the at least one eye in a three-dimensional (3D) space, an angular orientation of the at least one eye in the 3D space, a gazeline of the at least one eye in the 3D space, and a spatial location of a gazepoint of the at least one eye in the 3D space.

2. The system of claim 1, wherein the TOF device has a programmatically adjustable area-of-interest (AOI) over which it is sensitive to received light.

3. The system of claim 2, wherein the processor further uses the location of the at least one eye image within the at least one eyetracking camera image to programmatically adjust the AOI of the TOF device to align the AOI in real time on a spatial area of the at least one eye or on a spatial area including both eyes of the user.

4. The system of claim 2, wherein the processor further uses the location of the at least one eye image within the at least one eyetracking camera image to programmatically adjust the AOI of the TOF device to align the AOI in real time on a spatial area of a face of the user above the at least one eye or above both eyes of the user.

5. The system of claim 1, wherein the processor further calculates a camera-to-eye distance from the eyetracking camera to the at least one eye as a sum of a) the TOF-to-eye range measured by the TOF device and b) a set of known or estimated offset corrections that includes one or more of i) known or estimated offset corrections between the spatial location and angular orientation of the TOF device with respect to the spatial location and angular orientation of the eyetracking camera and ii) known or estimated offset corrections between the spatial location of the at least one eye and a spatial location of other facial features or items attached to a head or a face of the user that the TOF device detects.

6. The system of claim 2, wherein the AOI is adjusted to include just one eye of the user.

7. The system of claim 2, wherein the AOI is adjusted to include both eyes of the user.

8. The system of claim 2, wherein the AOI is adjusted to include a spatial area of a face of the user above the at least one eye or above both eyes of the user.

9. The system of claim 2, wherein the AOI is adjusted to include only one eye at a time and alternate between both eyes of the user in order to provide a separate distance measurement for each of the two eyes of the user.

10. The system of claim 2, wherein the AOI is adjusted to have a center on the opposite side of the at least one eye from a nose of the user.

11. A method for eyetracking, comprising:
capturing at least one image of at least one eye of a user using an eyetracking camera;
measuring a time-of-flight (TOF)-to-eye range from a light imaging and ranging TOF device to the at least one eye using the TOF device;
identifying the at least one eye image within the at least one eyetracking camera image using a processor;
calculating one or more of a spatial location of the at least one eye in a three-dimensional (3D) space, an angular orientation of the at least one eye in the 3D space, a gazeline of the at least one eye in the 3D space, and a spatial location of a gazepoint of the at least one eye in the 3D space using the measured TOF-to-eye range and the at least one eyetracking camera image.

12. The method of claim 11, wherein the TOF device has a programmatically adjustable area-of-interest (AOI) over which it is sensitive to received light.

13. The method of claim 12, wherein the processor further uses the location of the at least one eye image within the at least one eyetracking camera image to programmatically adjust the AOI of the TOF device to align the AOI in real time on a spatial area of the at least one eye or on a spatial area including both eyes of the user.

14. The method of claim 12, wherein the processor further uses the location of the at least one eye image within the at least one eyetracking camera image to programmatically adjust the AOI of the TOF device to align the AOI in real time on a spatial area of a face of the user above the at least one eye or above both eyes of the user.

15. The method of claim 11, wherein the processor further calculates a camera-to-eye distance from the eyetracking camera to the at least one eye as a sum of a) the TOF-to-eye range measured by the TOF device and b) a set of known or estimated offset corrections that includes one or more of i) known or estimated offset corrections between the spatial location and angular orientation of the TOF device with respect to the spatial location of the eyetracking camera and ii) known or estimated offset corrections between the spatial location of the at least one eye and a spatial location of other facial features or items attached to a head or a face of the user that the TOF device detects.

16. The method of claim 12, wherein the AOI is adjusted to include just one eye of the user.

17. The method of claim 12, wherein the AOI is adjusted to include both eyes of the user.

18. The method of claim 12, wherein the AOI is adjusted to include only one eye at a time and alternate between both eyes of the user in order to provide a separate distance measurement for each of the two eyes of the user

19. The method of claim 12, wherein the AOI is adjusted to have a center on the opposite side of the at least one eye from a nose of the user.

20. A computer program product, comprising a non-transitory and tangible computer-readable storage medium whose contents include a program with instructions being executed on a processor to perform a method for eyetracking, the method comprising:
providing a system, wherein the system comprises one or more distinct software modules, and wherein the distinct software modules comprise a control module and an analysis module;
instructing an eyetracking camera to capture at least one image of at least one eye of a user using the control module;
instructing a light imaging and ranging time-of-flight (TOF) device to measure a distance from the TOF device to the at least one eye using the control module;
identifying the at least one eye within the at least one image using the analysis module;
calculating a spatial location and an angular orientation of the at least one eye within the at least one image using the analysis module; and
calculating one or more of a spatial location of the at least one eye in a three-dimensional (3D) space, an angular orientation of the at least one eye in the 3D space, a gazeline of the at least one eye in the 3D space, and a location of a gazepoint of the at least one eye in the 3D space using the measured distance, the spatial location and angular orientation of the at least one eye within the at least one image, a spatial location and an angular orientation of the camera, and a spatial location and an angular orientation of the TOF device using the analysis module.
